(19) United States
(12) Patent Application Publication
(10) Pub. No.: US 2003/0101521 A1
(43) Pub. Date: Jun. 5, 2003

(54) Method of adsorbing dye in aqueous solution by chemical cross-linked chitosan beads

(76) Inventors: Ming-Shen Chiou, Taoyuan (TW); Hsing-Ya Li, Hsinchu (TW)

Correspondence Address: PERKINS COIE LLP, PATENT-SEA, P.O. BOX 1247, SEATTLE, WA, 98111-1247, US

(21) Appl. No.: 10/151,755

(22) Filed: May 16, 2002

(30) Foreign Application Priority Data
Nov. 27, 2001 (TW) 90129353

(51) Int. Cl. D06P 1/00

(52) U.S. Cl. 8/550

(57) ABSTRACT

The present invention provides a method of adsorbing dye by cross-linked chitosan beads comprising the steps of providing chitosan and dissolving the chitosan to form a chitosan solution, mixing the chitosan solution with a tripolyphosphate (TPP) solution to form ionic cross-linked chitosan beads, cross-linking the ionic cross-linked beads to form the cross-linked chitosan beads by adding NaOH and cross-linking agent and shaking for about a first period at temperature about 25-55 centigrade; and adding the cross-linked chitosan beads in dye solution to adsorb the dye. The cross-linked chitosan beads is used in acid or neutral solution to adsorb reactive type dye, acid type dye or direct type dye.

### TECHNICAL FIELD

The present invention relates to a method of adsorbing dye in aqueous solution, and more specifically, to a method of adsorbing dye by using cross-linked chitosan beads.

### BACKGROUND

The effluents of wastewater in some industries such as dyestuff, textiles, leather, paper, plastics, etc. contain various kinds of synthetic dyestuffs. A very small amount of dye in water is highly visible and can be toxic to creatures in water. Environmental legislation has imposed strict limits on the concentrations of dyes which may be discharged into nature bodies. Hence, the removal of color from process or waste effluents becomes environmentally important. Among several chemical and physical methods, adsorption process is an effective method to remove dyes from wastewater. Many studies have been made on the possibility of adsorbents to lower dye concentrations from aqueous solutions, such as activated carbon (McKay, 1983; Allen, 1996), please refer to Allen, S. J., 1996. Types of adsorbent materials. In: McKay, G. (Ed.), Use of Adsorbents for the Removal of Pollutants from Wastewaters. CRC, Boca Raton, USA, pp. 59-97.

Ramakrishna disclosed a method of removing dye by using peat, please refer to Ramakrishna, K. R., Viraraghavan, T., 1997. Dye removal using low cost adsorbents. Wat. Sci. Tech. 36, 189-196.

Another prior art may refer to Ho, Y. S., McKay, G., 1998. Sorption of dye from aqueous solution by peat. Chem. Eng. J. 70, 115-124. Chitin is also applied in the field to adsorb the dye in the solution such as the article disclosed by McKay, G., Blair, H. S., Gardner, J. R., 1983. Rate studies for the adsorption of dyestuffs on chitin. J. Colloid and Interface Sci. 95, 108-119. Juang R. S., Tseng, R. L., Wu, F. C., Lee, S. H., 1997. Adsorption behavior of reactive dyes from aqueous solutions on chitosan. J. Chem. Technol. Biotechnol. 70, 391-399.

Other method uses silica to achieve the purpose such as McKay, G., 1984. Analytical solution using a pore diffusion model for a pseudoirreversible isotherm for the adsorption of basic dye on silica. AlChE J. 30, 692-697.

Further prior art includes the articles suggested by El-Geundi, M. S., 1991. Color removal from textile effluents by adsorption techniques. Wat. Res. 25, 271-273.

Hu, T. L., 1996. Removal of reactive dyes from aqueous solution by different bacterial genera. Wat. Sci. Tech. 34, 89-95.Low, K. S., Lee, C. K., 1997. Quaternized rice husk as sorbent for reactive dyes. Bioresource Tech. 61, 121-125.

Namasivayam C., Prabha, D., Kumutha, M., 1998. Removal of direct red and acid brilliant blue by adsorption on to banana pith. Biores. Technol. 64, 77-79.

Tsai, W. T., Chang, C. Y., Lin, M. C., Chien, S. F., Sun, H. F., Hsieh, M. F., 2001. Adsorption of acid dye onto activated carbon prepared from agricultural waste bagasse by ZnCl₂ activation. Chemosphere. 45, 51-58.

Aksu, Z., Tezer, S., 2000. Equilibrium and kinetic modelling of biosorption of remazol black B by rhizopus arrhizus in a batch system: effect of temperature. Process Biochem. 36, 431-439.

For both regenerative and non-regenerative systems, high adsorption capacity is essential for adsorbent selection. However, the amount (g) of dyes adsorbed on the above adsorbents (kg) are not very high, some have capacities of 200-600 g/kg and some even lower than 50 g/kg. To improve adsorption performance researches on new absorbents are still under development.

Chitosan is the deacetylated form of chitin, which is a linear polymer of acetylamino-D-glucose and contains high contents of amino and hydroxyl functional groups. Recently, chitosan used as an adsorbent has drawn attentions due to its ability of forming covalent binding and electrostatic attraction between chitosan and solutes. Chitosan has been observed for the high potentials of the adsorption of dyes. For example, Yoshida, H., Okamoto, A., Kataoka, T., 1993 disclosed the related technology. Adsorption of acid dye on cross-linked chitosan fibers: equilibria. Chem. Eng. Sci. 48, 2267-2272. Other prior art such as Wu, F. C., Tseng, R. L., Juang, R. S., 2000. Comparative adsorption of metal and dye on flake- and bead-types of chitosans prepared from fishery wastes. J. Hazard. Mater. B73, 63-75.

Adsorption of metal ions by chitosan such as Guibal, E., Milot, C., Tobin, J. M., 1998. Metal-anion sorption by chitosan beads: equilibrium and kinetic studies. Ind. Eng. Chem. Res. 37, 1454-1463. The chitosan may be used to absorb proteins (Zeng and Ruckenstein, 1998). Other useful features of chitosan include its abundance, non-toxicity, hydro-philicity, biocompatibility, biodegradability, and anti-bacterial property (Kumar, M. N. V. R., 2000. A review of chitin and chitosan applications. React. & Funct. Polym. 46, 1-27).

The adsorption of reactive dyes in neutral solutions using chitosan shows large adsorption capacities of 1000-1100 g/kg (Wu et al., 2000). In acid aqueous solutions, the amino groups of chitosan are much easier to be cationized and they adsorb the dye anions strongly by electrostatic attraction (Kumar, 2000). Moreover, it is also useful to study the dye-binding capacity of chitosan below pH 7, since acetic acid is often used as a stimulator in the dying process, in which the pH of the dye solution is normally adjusted to 3-4. However, chitosan formed gels below pH 5.5 and could not be evaluated. The acid effluent could severely limit the use of chitosan as an adsorbent in removing dyes and mental ions due to chitosan's dissolution tendency in the acid effluent. To stabilize chitosan in acid solutions, some cross-linking reagents are used (Wei et al., 1992; Zeng and Ruckenstein, 1996). Please refer following articles: Wei, Y. C., Hudson, S. M., Mayer, J. M., Kaplan, D. L., 1992. The crosslinking of chitosan fibers. J. Polym. Sci.: Polym. Chem. 30, 2187-2193. Zeng, X. F., Ruckenstein, E., 1998. Cross-linked macroporous chitosan anion-exchange membranes for protein separations. J. Membr. Sci. 148, 195-205.

Cross-linked chitosan is insoluble in acid solution and its mechanical properties are improved. Yoshida et al. (1993) used Denacol EX841 as a cross-linking reagent and obtained a high adsorption capacity (1200-1700 g/kg) of Acid Orange II (acid dye) on the cross-linked chitosan fibers in acid solutions of pH 3.0 and 4.0.

What is need is a method of adsorbing dye in an acid solution with superiors adsorption.

### SUMMARY

In order to increase the adsorption capacity of chitosan, the object of the present invention is to provide a method of adsorbing dye in an acid aqueous solution.

The yet object of the present invention is to provide a method of adsorbing dye in an acid solution by using chemical cross-linked chitosan beads.

The further object of the present invention is to use cross-linked chitosan by epichlorohydrin (ECH) to obtained a high adsorption capacity (1600-1900 g/kg) of reactive dye (RR 189) on the cross-linked chitosan beads in acid aqueous solutions of pH 3.0. It appears technically and economically feasible to remove acid and reactive dyes from acid aqueous solutions by cross-linked chitosan.

The present invention provides a method of adsorbing dye by cross-linked chitosan beads comprising the steps of providing chitosan and dissolving the chitosan to form a chitosan solution;mixing the chitosan solution with a tripolyphosphate (TPP) solution to form ionic cross-linked chitosan beads; cross-linking the ionic cross-linked chitosan beads to form the cross-linked chitosan beads by adding NaOH and the cross-linking agent and shaking for about a first period at a temperature about 25-55 centigrade; and adding the cross-linked chitosan beads in a dye solution to adsorb the dye.

Wherein the chitosan is dissolved in acetic acid solution. wherein the cross-linking agent includes epichlorohydrin (ECH) glutaraldehyde (GA) or ethylene glycol diglycidyl ether (EGDE).

### DESCRIPTION OF THE DRAWINGS

FIG. 1 illustrates the process flow according to the present invention.

FIG. 1A displays the structure of dye RR 189.

FIG. 2 shows the effect of the cross-linking reagent with various molar ratios to chitosan (cross-linking molar ratio) on the adsorption capacity of RR 189 onto cross-linked chitosan beads.

FIG. 3 shows that the equilibrium adsorption capacities of dye RR189 on cross-linked chitosan beads made of molecular weight 150000, 220000, 400000, and 600000.

FIG. 4 shows the equilibrium adsorption of RR 189 at pH 3.0, 30° C., on the cross-linked chitosan beads for three different particle sizes and one size of non-cross-linked chitosan beads (pH 6.0).

FIG. 5 shows that the effect of initial RR 189 concentration on the adsorption kinetics of the cross-linked chitosan at pH 3.0, 30° C.

FIG. 6 shows the effect of temperature on adsorption of RR 189 onto the cross-linked chitosan at pH 3.0 and initial dye concentration 4330 g/m³.

FIG. 7 shows the effect of pH on adsorption of RR 189 onto chitosan at 30° C., and initial dye concentration 4571 g/m³.

FIG. 8 shows 48-hr adsorption capacities of the cross-linked chitosan beads (pH 1.0-9.0) and the non-cross-linked chitosan beads (pH 6.0-9.0).

FIG. 9 shows the kinetics of adsorption of RR189 on both wet and dry cross-linked chitosan beads at pH 1.0, 30° C., and initial dye concentration 4571 g/m³.

### DETAILED DESCRIPTION

In this work, to shorten the formation time of the chitosan beads and to improve their structural strength, the solution of sodium tripolyphosphate (TPP) was used to produce more rigid beads via its ionic cross-linking effect in the beads formation step. Also three reagents including epichlorohydrin (ECH), glutaraldehyde (GA), and ethylene glycol diglycidyl ether (EGDE) were used in chemical cross-linking and compared in their adsorption behaviors. Chitosan with different molecular weight and different degree of deacetylation was used to evaluate the adsorption capacity. We investigated the equilibrium and kinetics of adsorption of reactive red 189 (RR189) on the chitosan in solutions of pH 1-9. The Langmuir and Freundlich equations were used to fit the equilibrium isotherm. The dynamical behaviors of the adsorption were measured on the effect of initial dye concentration, temperature, solution pH value, and wet/dry chitosan beads. The adsorption rates were determined quantitatively and compared by the pseudo first-order, second-order models and the intraparticle diffusion equation.

Chemical

The first step is to prepare the Chitosan bead, one of the methods is used for an example rather than limiting the present invention.

Chitosan α-type;

degree of deacetylation: 84.5-85.5%, 95%;

molecular weight: 150000, 200000, 220000, 400000, 600000 Reagents ECH (≧98%), GA (50%), EGDE (50%) and TPP (≧98%)

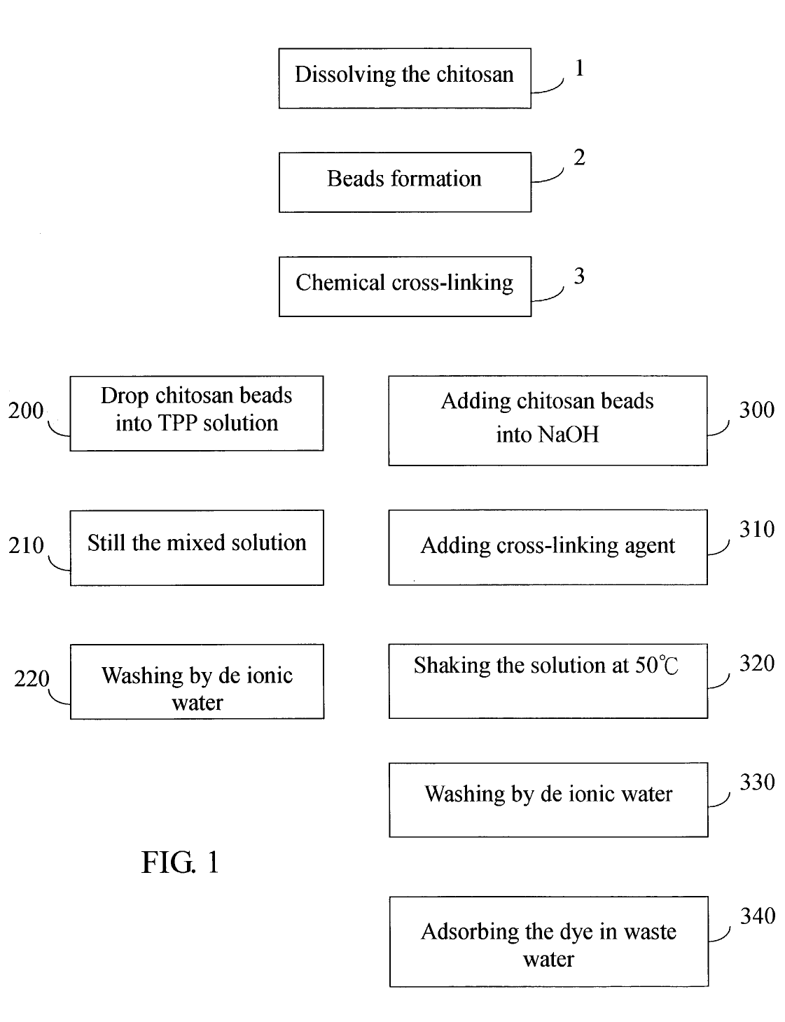

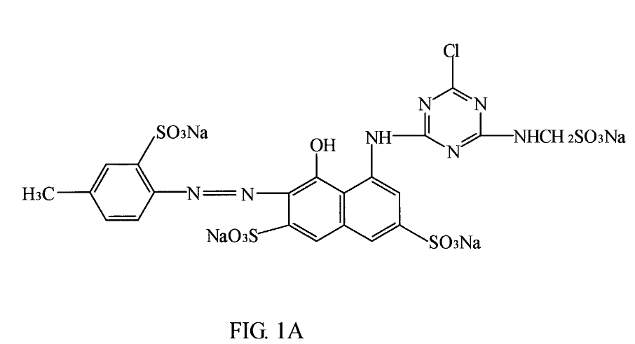

The commercial reactive dye 189 (RR 189, C.I. 18210) was used as received. FIG. 1A displays the structure of dye RR 189. The buffer solution to adjust pH of aqueous solutions contained sodium acetate-3-hydrate (wt.>99%, RDH) and acetic acid (ACS grade, TEDIA).

Preparation of Chitosan Beads

The preparation of chitosan beads involves three steps (please refer to FIG. 1):

1. chitosan dissolution

2. beads formation

3. chemical cross-linking

The following parameters are used as an example rather than limiting the scope of the present invention. 10.0 g of chitosan were dissolved in 300 cm³, 5 wt. % of acetic acid solution. The aqueous solution was diluted to 1.0 dm³ by strong stirring over night, and then let it stay still for 6-24 hours.

Chitosan solution prepared from step (1) was poured into a 50-cm³ burette equipped with a micro-pipette tip. 10 cm³ of the chitosan solution were dropped from the burette into a 100-cm³ aqueous solution of TPP (1 wt. %), step 200. The chitosan droplets formed bead shape in the still solution for 4 hours (210). The diameters of the droplets were controlled via various tips of the micro-pipette. The chitosan beads were filtered out, washed with deionized water, and were stored in distilled water for using (220). In this way we prepared wet non-cross-linked chitosan beads with three different diameters (mm): small (2.3˜2.5), medium (2.5˜2.7), and large (3.5˜3.8). In the bead formation step, the ionic cross-linking reagent TPP was used to strength the structure of chitosan beads. These beads are more rigid because of the ionic attractions between P₃O₁₀⁵⁻ (TPP) and the —NH₃⁺ group of chitosan in acid solutions. This improves the mechanical properties of the chitosan beads. The time required to form beads was larger than 4 hours.

The wet non-cross-linked chitosan beads (containing 0.1 g dry basis of chitosan) and 50 cm³, 1N sodium hydroxide solution were put together in a 125-cm³ flask, step 300. Next, step 310 cross-linking reagent ECH, GA or EGDE was added respectively into the above solution, and shook for 6 hours at 50° C. with a water bath (320). Chitosan beads with different molar ratios of cross-linking reagents/chitosan (cross-linking ratio: 0.174, 0.348, 0.523, 0.697 and 0.871) were prepared in this work. The cross-linked chitosan beads were filtered out, washed with deionized water, and stored in distilled water for using, step 330. Dry cross-linked chitosan beads were used in some experiments. They were obtained from the wet cross-linked beads after staying in a vacuumed chamber at room temperature for 24 hours. Next, the cross-linked chitosan beads is used to adsorb dye in solution (340).

Preferred Embodiment

Dye RR 189 was dissolved in deionized water to the required concentrations. The pH of dye solutions was adjusted by buffer solutions of acetic acid/acetate. In experiments of equilibrium adsorption isotherm, chitosan beads (containing 0.1 g dry basis of chitosan) and 50 cm³ dye solution were put in a 125-cm³ flask, which contained acetic acid buffer solution with desired pH value, and were shook for 5 days using a bath to control the temperature at 30±1° C. (The solution pH was adjusted to 1.0 or 2.0 by concentrated HC1, and to 9.0 by NaOH.) In order to measure the dye concentration, the solutions were adjusted to pH 6.0 and analyzed at wavelength 534 nm by an UV/Visible spectrometer (JASCO V-530). Equation (1) was used to calculate the amount of adsorption at equilibrium qₑ (g/kg):

qₑ=(C₀−Cₑ)V/W (1)

where C₀ and Cₑ are the initial and equilibrium solution concentrations, respectively (g/m³), V is volume of the solutions (m³), and W is the weight of chitosan used (dry basis, kg).

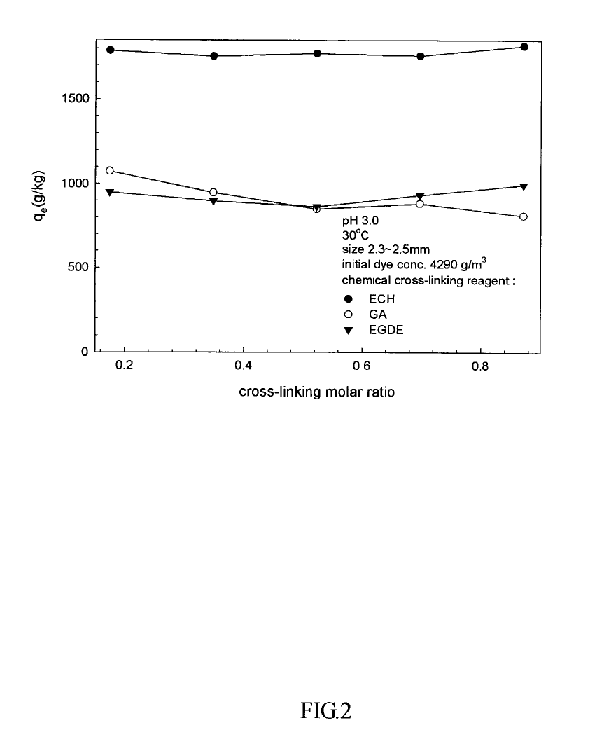

Three chemical cross-linking reagents ECH, GA and EGDE were evaluated in the present invention. FIG. 2 shows the effect of the cross-linking reagent with various molar ratios to chitosan (cross-linking molar ratio) on the adsorption capacity of RR 189 onto cross-linked chitosan beads at particle size 2.3-2.5 mm, pH 3.0, 30° C., and initial dye concentration 4290 g/m³. The result indicates that the cross-linking ratio affects slightly the equilibrium adsorption capacity for the three cross-linking reagents under the range we studied. The maximum qₑ appears at molar ratio 0.871, 0.174 and 0.871 for ECH, GA and EGDE, respectively. FIG. 2 also shows that the maximum adsorption capacity for using ECH is 69% and 83% higher than that of GA and EGDE, respectively. This result may be explained by that the different functional groups of chitosan were involved in the chemical cross-linking reaction as different reagents were used. ECH cross-links chitosan molecules by connecting mostly with the —OH group of chitosan (Zeng and Ruckenstein, 1996), whereas GA and EGDE connecting with more —NH₂ group (Guibal et al., 1999; Zeng and Ruckenstein, 1998). Therefore GA and EGDE reduce the major adsorption site (—NH₃⁺) on chitosan attracting the anion of dye RR 189 via electrostatic interaction. The reagent ECH (with cross-linking ratio 0.523) was used as the chemical cross-linking reagent for all other studies in the present invention.

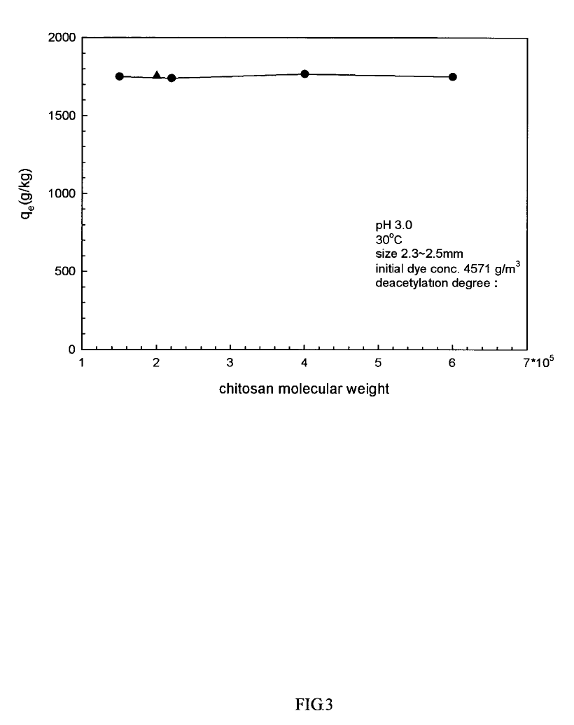

Chitosan with different molecular weight and degree of deacetylation was used to evaluate adsorption ability. FIG. 3 shows that the equilibrium adsorption capacities of dye RR189 on cross-linked chitosan beads made of molecular weight 150000, 220000, 400000, and 600000 (degree of deacetylation 84.5-85.5%) are almost the same at particle size 2.3-2.5 mm, pH 3.0, 30° C., and initial dye concentration 4571 g/m³.

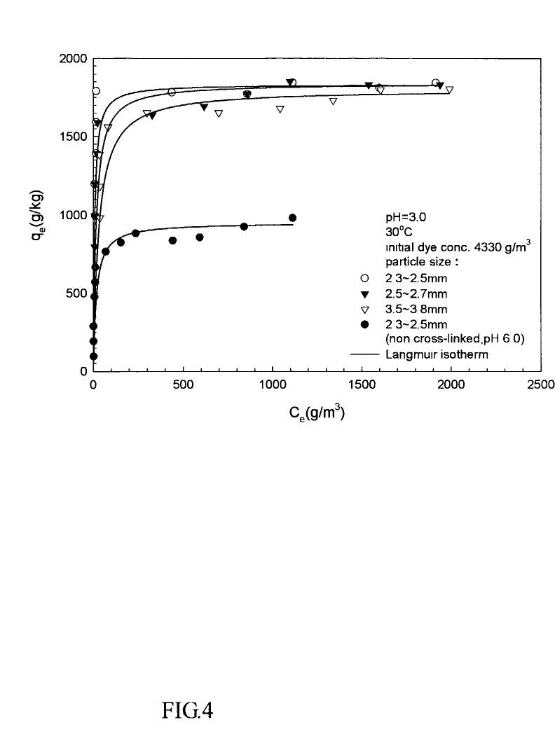

FIG. 4 shows the equilibrium adsorption of RR 189 at pH 3.0, 30° C. on the cross-linked chitosan beads for three different particle sizes and one size of non-cross-linked chitosan beads (pH 6.0). It is seen that the saturation adsorption of cross-linked chitosan beads at pH 3.0 is almost 90% larger than that of the non-cross-linked chitosan beads at pH 6. This may suggest that at low pH chitosan's free amino groups are protonated, causing them to attract anionic dye. The cross-linked chitosan beads not only are insoluble below pH 5.5 but also largely increase the adsorption capacity of RR 189. FIG. 4 also indicates that the adsorption capacity at smaller Cₑ (<400 g/m³) decreases slightly with increasing the diameter of the chitosan bead, while they are close to each others at higher Cₑ (1500˜2000 g/m³). FIG. 4 also shows that the time to achieve equilibrium decreases with reducing the bead diameter. Thus, the chitosan beads of particle size 2.3-2.5 mm were used in the experiments.

Equilibrium adsorption isotherm is fundamental to describe the interact behavior between solutes and adsorbent and is important in the design of adsorption system. Parameters of the Langmuir and Freundlich isotherm were computed in Table 1. The Langmuir isotherm fits quite well with the experimental data for the three different particle sizes at pH 3.0 (correlation coefficient, R²>0.999), whereas the low correlation coefficients (R²<0.742) show the poor agreements of Freundllich isotherm with the experimental data. Table 1 indicates that the computed maximum monolayer capacity Q of RR 189 on the cross-linked chitosan beads has large value, ranging from 1802˜1840 g/kg.

The widely used Langmuir isotherm has found successful application to many real sorption processes and is expressed as:

$${q}_{e} = \frac{{QbC}_{e}}{1 + {bC}_{e}} \qquad ( 2 )$$

where Q (g/kg) is the maximum amount of the dye per unit weight of chitosan to form a complete monolayer coverage on the surface bound at high equilibrium dye concentration Cₑ, and b is the Langmuir constant related to the affinity of binding sites (m³/g). Q represents a practical limiting adsorption capacity when the surface is fully covered with dye molecules and assists in the comparison of adsorption performance. Q and b are computed from the slopes and intercepts of the straight lines of plot of (Cₑ/qₑ) vs. Cₑ.

The well-known Freundlich isotherm used for isothermal adsorption is a case for heterogeneous surface energy in which the energy term in the Langmuir equation varies as function of surface coverage strictly due to variation of the sorption. The Freundlich equation is given as

qₑ=Q_{ƒ}Cₑ^{1/n} (3)

where Q_{ƒ} is roughly an indicator of the adsorption capacity and (1/n) of the adsorption intensity. The magnitude of the exponent 1/n gives an indication of the favorability of adsorption. Values n>1 represent favorable adsorption condition (McKay et al., 1982). Q_{ƒ} and 1/n can be determined from the linear plot of In(qₑ) vs. In(Cₑ).

The excellent performance of the present invention can be seen in Table 2. Table 2 lists the comparison of maximum monolayer adsorption capacity of some dyes on various adsorbents. Compared with some data in literatures, Table 2 shows that the cross-linked chitosan beads studied in this work have relatively large adsorption capacity of RR 189 at pH 3.0.

In order to investigate the mechanism of adsorption, the pseudo first-order adsorption, the pseudo second-order adsorption and the intraparticle diffusion model were used to test dynamical experimental data. The first-order rate expression of Lagergren is given as (Lagergren, S., 1898. Zur theorie der sogenannten adsorption geloster stoffe. Kungliga Svenska Vetenskapsakademiens. Handlingar, 24,1-39):

$$log ( {q}_{e} - q ) = log {q}_{e} - \frac{{k}_{1}}{2.303} t \qquad ( 4 )$$

where qₑ and q are the amounts of dye adsorbed on adsorbent at equilibrium and at time t, respectively (g/kg) and κ₁ is the rate constant of first-order adsorption (min⁻¹). The slopes and intercepts of plots of log(qₑ−q) vs. t were used to determine the first-order rate constant κ₁. In many cases the first-order equation of Lagergren does not fit well to the whole range of contact time and is generally applicable over the initial stage of the adsorption processes (McKay, G., Ho, Y. S., 1999a. The sorption of lead (II) on peat. Wat. Res. 33, 578-584).

The second-order kinetic model (McKay, G., Ho, Y. S., 1999b. Pseudo-second order model for sorption processes. Process Biochem. 34, 451-465.) is expressed as

$$\frac{t}{q} = \frac{1}{{k}_{2} {q}_{e}^{2}} + \frac{t}{{q}_{e}} \qquad ( 5 )$$

and

h=κ₂qₑ² (6)

where κ₂ (kg g⁻¹ min⁻¹) is the rate constant of second-order adsorption and h is the initial adsorption rate (g kg⁻¹ min-⁻¹). The slopes and intercepts of plots of t/q vs. t were used to calculate the second-order rate constant κ₂ and qₑ. It is more likely to predict the behavior over the whole range of adsorption and is in agreement with an adsorption mechanism being the rate-controlling step (McKay and Ho, 1999a, 1999b).

The intraparticle diffusion equation can be described as:

q=κ₁t^{0.5} (7)

where κ₁ is intraparticle diffusion rate constant (g kg⁻¹ min^{-0.5}). The κ₁ is the slop of straight-line portions of plot of q vs. t^{0.5}.

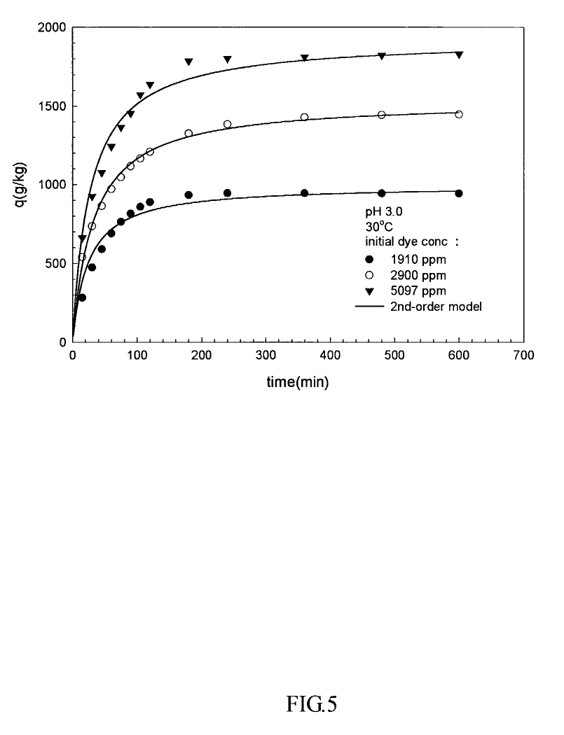

FIG. 5 shows that the effect of initial RR 189 concentration on the adsorption kinetics of the cross-linked chitosan at pH 3.0, 30° C. An increase in initial dye concentration leads to an increase in the adsorption capacity of dye on chitosan. The adsorption capacity for 10 hr with initial dye concentration at 3839 and 2900 g/m³ is 72% and 58% larger than that at 1910 g/m³, respectively. This indicates that the initial dye concentration plays an important role in the adsorption capacity of RR189 on the cross-linked chitosan beads.

Table 3 lists the results of rate constant studies for different initial dye concentrations by the pseudo first-order, second-order models and the intraparticle diffusion model. The correlation coefficient R² for the pseudo second-order adsorption model has extremely high value (>0.998), and its calculated equilibrium adsorption capacities q_{e,cal} fit well with the experimental data. The results in Table 3 also show the rate constant, κ₂, initial adsorption rate, h, and the equilibrium adsorption capacity, qₑ, as a function of initial dye concentration. An increase in initial dye concentration results in significant increasing the equilibrium adsorption capacity q_{e,cal}. The q_{e,cal} for initial dye concentration at 5096 and 2900 g/m³ is 93% and 54% larger than that of at 1910 g/m³, respectively.

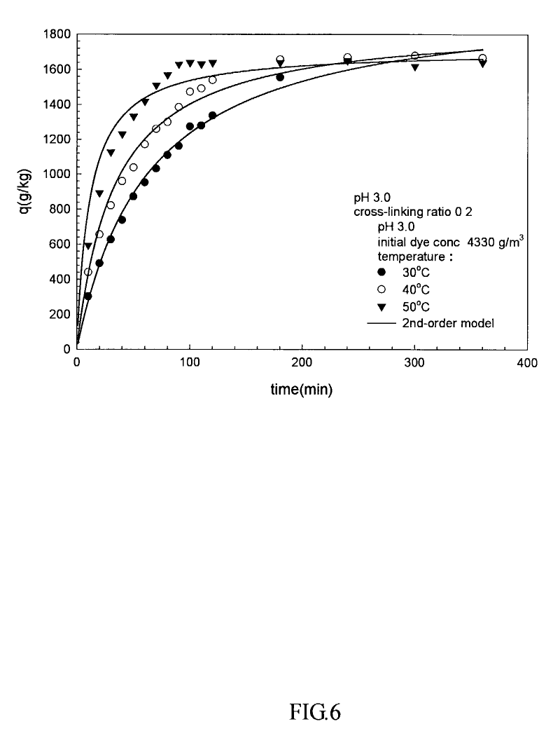

FIG. 6 shows the effect of temperature on adsorption of RR 189 onto the cross-linked chitosan at pH 3.0 and initial dye concentration 4330 g/m³. An increase in the temperature leads to an increase in initial adsorption rate, but the adsorption capacities at 6 hr are close to each other. Normal wastewater temperature variations do not significantly affect the overall decolorization performance (Kumar, 2000). However, a significant effect of temperature on the equilibrium isotherm was observed in the low equilibrium dye concentration range (<1 mol/m³) for adsorption of Acid Orange II (acid dye) on cross-linked chitosan (Yoshida et al., 1993).

Table 3 lists the results of rate constant studies for different temperatures calculated by the three models. The correlation coefficient R² for the pseudo second-order adsorption model has the highest value (=0.997) suggesting the dye adsorption process is predominant by the pseudo second-order adsorption mechanism. The experimental adsorption capacity qₜ at 6 hr reaches 83%, 90% and 96% of the predicted equilibrium adsorption capacities q_{e,cal} at 30° C., 40° C. and 50° C., respectively. This suggests that the equilibrium time is shorter with increasing temperature. It may be explained by that higher temperature increases the reaction rate and decreases the particle density, which forms larger pore size and is easier for dye molecule to diffuse. For the pseudo second-order model, both the rate constant and the initial adsorption rate increase significantly with an increasing of temperature from 30° C. to 50° C. In Table 3, the rate constant at 50° C. and 40° C. is, respectively, 6.46 and 2.04 times of that at 30° C. whereas the initial adsorption rate at 50° C. and 40° C. is, respectively, 4.66 and 1.76 times of that at 30° C. An increase in temperature from 30° C. to 50° C. leads to an decrease in the calculated equilibrium adsorption capacity q_{e,cal}. The value of q_{e,cal} at 30° C. and 40° C. is 18% and 9% larger than that at 50° C., respectively.

The thermodynamic parameters such as change in free energy (ΔG⁰), enthalpy (ΔH⁰) and entropy (ΔS⁰) were determined using the following equations:

$${K}_{c} = \frac{{C}_{A e}}{{C}_{e}} \qquad ( 8 )$$

ΔG⁰=−RT ln K_{C} (9)

$$log {K}_{C} = \frac{Δ {S}^{0}}{2.303 R} - \frac{Δ {H}^{0}}{2.303 RT} \qquad ( 10 )$$

where K_{C} is the equilibrium constant, C_{Ae} is the amount of dye (mg) adsorbed on the adsorbent per dm³ of the solution at equilibrium, Cₑ is the equilibrium concentration (mg/dm³) of the dye in the solution, T is the solution temperature (K) and R is the gas constant. ΔH⁰ and ΔS⁰ were calculated from the slop and intercept of van't Hoff plots of log K_{C} vs. 1/T The results are listed in Table 4. (The q_{e,cal} of the pseudo second-order model in Table 3 was used to obtain C_{Ae}.) The negative values of ΔG⁰ indicate that the adsorption of dye RR189 on the cross-linked chitosan is spontaneous. The negative value of ΔH⁰ shows that the adsorption is an exothermic process. The negative value of ΔS⁰ indicates that the randomness decreases at the solid-solution interface during the adsorption of dye on the cross-linked chitosan.

The rate constant κ for pseudo second-order reaction shows an Arrhenius dependence on reciprocal temperature. The relationship can be expressed by:

$$k = {k}_{0} exp ( \frac{- {E}_{ad}}{RT} ) \qquad ( 11 )$$

where κ is the rate constant of adsorption, κ₀ is the temperature independent factor (kg g⁻¹ min⁻¹), and Ε_{ad} is the activation energy (J/mol) for the adsorption. The values of κ₀ and Ε_{ad} are calculated from the slop and intercept of a plot of ln(κ) vs. 1/T The results are listed in Table 4. Therefore, the relationship between κ and T can be represented in an Arrhenius form as:

$$k = 8.107 \times {10}^{7} exp ( \frac{- 75.708 \times {10}^{3}}{8.314 T} ) \qquad ( 12 )$$

The relationship between the activation energies of adsorption, Ε_{ad}, and desorption, Ε_{de}, is described by

ΔH⁰=Ε_{ad}−Ε_{de} (13)

According to the values in Table 4, the activation energy of desorption, Ε_{de}, is estimated to be 128.656 kJ/mol, whose large value might indicate the difficulty for desorption of the adsorbed dye RR 189 from the surface of the cross-linked chitosan into solutions.

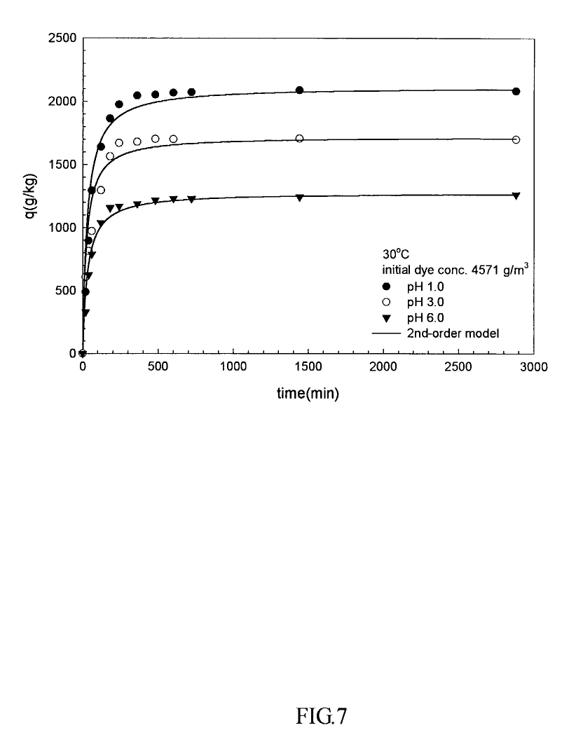

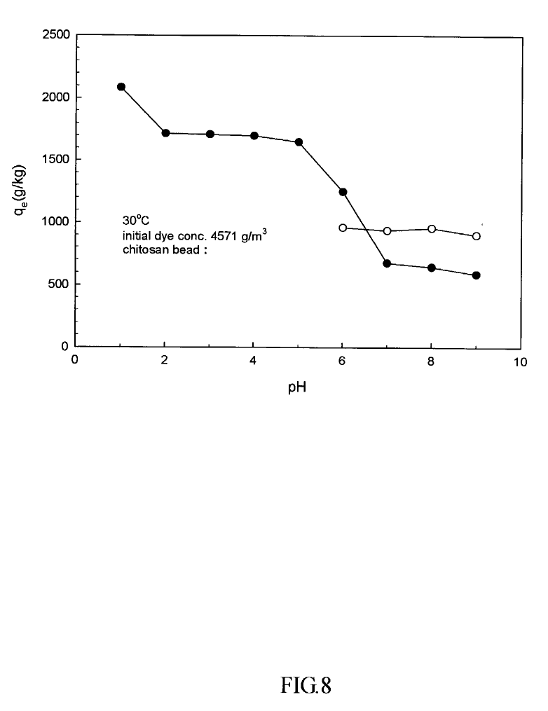

FIG. 7 shows the effect of pH on adsorption of RR 189 onto chitosan at 30° C., and initial dye concentration 4571 g/m³. It shows that the adsorption capacity increases significantly with decreasing the pH. Under the same operating conditions as FIG. 7, FIG. 8 shows 48-hr adsorption capacities of the cross-linked chitosan beads (pH 1.0-9.0) and the non-cross-linked chitosan beads (pH 6.0-9.0). The solution pH strongly affects the adsorption capacity of the cross-linked chitosan whereas the capacity nearly remains constant for the non-cross-linked chitosan. The 48-hr amounts of adsorption of dye RR 189 on the cross-linked chitosan at pH 1.0, 3.0 and 6.0 are 118%, 78% and 32% higher than that of the non-cross-linked chitosan at pH 6.0, respectively. It can be seen that the pH of aqueous solution plays an important role in the adsorption of RR 189 onto chitosan. The similar results are also mentioned in (Yoshida et al., 1993; Kumar, 2000). From pH 7.0 to 9.0, the adsorption capacities of the cross-linked chitosan beads are smaller than the capacities of the non-cross-linked chitosan beads. This might be explained by that the chemical cross-linking reduces either the total number and/or the diameter of the pores in chitosan beads, making the dye molecule more difficult to transfer.

Table 3 lists the results of rate constant studies for different pH calculated by the three models. The correlation coefficient R² for the pseudo second-order adsorption model has extremely high value (=1.000), and its calculated equilibrium adsorption cap q_{e,cal} fits very well with the experimental qₜ at 48 hr. These suggest that the pseudo second-order adsorption mechanism is predominant and that the overall rate of the dye adsorption process appears to be controlled by the chemical process. For the pseudo second-order model in Table 3, for cross-linked chitosan beads, the calculated equilibrium adsorption capacities, q_{e,cal}, at pH 1.0 and 3.0 are 66% and 34% larger than that at pH 6.0, respectively.

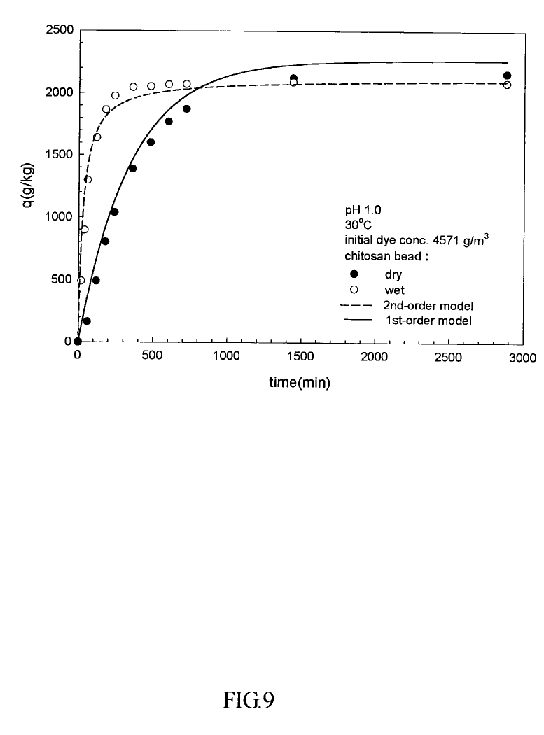

The chitosan beads used in the above experiments were wet. To find out the effect of dryness of beads on the adsorption rate, dried cross-linked chitosan beads were used to evaluate the adsorption behavior. The diameter of the dry beads shrinks to the size of 680.88±21.28 μm (measured by SEM, Hitachi S-2300), which is 2.4±0.1 mm as they are wet. FIG. 9 shows the kinetics of adsorption of RR189 on both wet and dry cross-linked chitosan beads at pH 1.0, 30° C., and initial dye concentration 4571 g/m³. According to FIG. 9, the adsorption rate for wet beads is much faster than that of dry beads and the time delay to reach similar adsorption capacity is about 18 hr, because it takes time for the dry beads to swell before adsorption takes place. However, the experimental adsorption capacity, qₜ, at 48 hr for both wet and dry beads are close to each other.

Table 3 lists the results of rate constant studies for wet and dry cross-linked chitosan beads calculated by the three models. Comparing the correlation coefficient R² and the calculated equilibrium adsorption capacity q_{e,cal}, the wet chitosan beads are again best described by the pseudo second-order adsorption model (R²=1.000). However, the dry beads are best modeled by the pseudo first-order kinetic model (R²=0.999) suggesting that the overall rate of the dye adsorption process on dry beads appears to be controlled by mass transfer.

A chitosan beads adsorbent comprising: pluralities of particle having average diameter about 680 micron meters for using in acid or neutral solution to adsorb reactive type dye, acid type dye or direct type dye, wherein said chitosan beads adsorbent is prepared by cross-linked chitosan adding ECH, GA or EGDE as the cross-linking agent.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

TABLE 1
Langmuir and Freundlich isotherm constants
at different particles sizes (30° C.)

| Particle | Langmuir | | | Freundlich | | |
|---|---|---|---|---|---|---|
| Sizes (mm) | Q (g/kg) | b (m³/g) | R² | Q_{f} | n | R² |

pH 3.0 (cross-linked)

| | | | | | | |
|---|---|---|---|---|---|---|
| Small: 2.3 ˜ 2.5 | 1834 | 0.1459 | 1.000 | 1147 | 15.00 | 0.553 |
| Medium: 2.5 ˜ 2.7 | 1840 | 0.0655 | 0.999 | 891 | 9.76 | 0.742 |
| Large: 3.5 ˜ 3.8 | 1802 | 0.0337 | 0.999 | 865 | 10.06 | 0.722 |
| pH 6.0 (non-cross- | | | | | | |
| linked) | | | | | | |
| Small: 2.3 ˜ 2.5 | 950 | 0.0606 | 0.995 | 231 | 4.35 | 0.716 |

TABLE 2
Comparison of the maximum monolayer adsorption capacities of some dyes on various adsorbents

| | | Maximum monolayer | |
|---|---|---|---|
| Dyes | Adsorbent | adsorption capacities (g/kg) | Reference |
| RR 189 | Chitosan bead (cross-linked, TPP) | 1802-1840 | This work |
| RR 189 | Chitosan bead (non-cross-linked, TPP) | 950 | This work |
| Acid Orange II | Chitosan fiber (cross-linked) | 1226-1678 | Yoshida et al. (1993) |
| RR 222 | Chitosan (non-cross-linked) | 1026-1106 | Wu et al. (2000) |
| RR 222 | Chitosan (non-cross-linked) | 299-380 | Juang et al. (1997) |
| RR 222 | Chitin | ˜100 | Juang et al. (1997) |
| RR 222 | Activated carbon | ˜50 | Juang et al. (1997) |
| RB 222 | Chitosan (non-cross-linked) | 54-87 | Juang et al. (1997) |
| RY 145 | Chitosan (non-cross-linked) | 117-179 | Juang et al. (1997) |
| Deorlene yellow | Activated carbon | ˜200 | McKay (1983) |
| Telon blue | Activated carbon | ˜160 | McKay (1983) |
| Astrazone blue | Silica | ˜25 | McKay (1984) |
| Mordant yellow 5 | Chitin | 52 | McKay et al. (1983) |
| AB 25 | Chitin | 183 | McKay et al. (1983) |
| AB 25 | Peat | 5-9 | Ho and McKay (1998) |
| AB 25 | Carbon, Peat, Alumina | 83-99 | Allen (1996) |
| AB 158 | Chitin | 216 | McKay et al. (1983) |
| BB 69 | Peat | 184-233 | Ho and McKay (1998) |
| BB 3 | Activated carbon, Fuller's earth | 448-560 | Allen (1996) |
| BR 22 | Activated carbon, Fuller's earth | 460-520 | Allen (1996) |
| Direct red 84 | Chitin | 44 | McKay et al. (1983) |
| RY 2 | Bacteria | 52-124 | Hu (1996) |
| RY 2 | Activated sludge | 333 | Aksu (2001) |
| RB 2 | Rice husk | 130 | Low and Lee (1997) |
| RB 2 | Activated sludge | 250 | Aksu (2001) |
| Remazol Black B | Fungus | 286-588 | Aksu and Tezer (2000) |
| AB 29 | Peat, Fly ash1 | 14-15 | Ramakrishna and Viraraghavan (1997) |
| BB 29 | Peat, Fly ash | 54-46 | Ramakrishna and Viraraghavan (1997) |
| Disperse Red 1 | Peat, Bentonite, Slag, Fly ash | 23-50 | Ramakrishna and Viraraghavan (1997) |
| Acid Brilliant Blue | Banana pith | 4-5 | Namasivayam et al. (1998) |
| Acid Violet 17 | Orange peel | 20 | Sivaraj et al. (2001) |
| Acid Orange 10 | Activated carbon | 2-6 | Tsai et al. (2001) |
| Astrazon Blue | Maize cob | 160 | El-Geundi (1991) |
| Erionyl Red | Maize cob | 48 | El-Geundi (1991) |

TABLE 3
Comparison of the first-order, second-order adsorption, and intraparticle diffusion
rate constants, calculated qₑ and experimental qₜ
values for different initial dye concentrations, temperatures, pH, and wet/dry beads

| | | First-order | | | | | | | Intraparticle | |
|---|---|---|---|---|---|---|---|---|---|---|
| | | kinetic model | | | Second-order kinetic model | | | | diffusion model | |
| | qₜ | k₁ | q_{e,cal} | | k₂ | h | q_{e,cal} | | k₁ | |
| Parameters | (g/kg) | (min⁻¹) | (g/kg) | R² | (kg g⁼¹ min⁻¹) | (g kg⁻¹ min⁻¹) | (g/kg) | R² | (kg g⁻¹ min⁻¹) | R² |

Initial dye conc. t = 10 hr (pH 3.0)
(g/m³)

| | | | | | | | | | | |
|---|---|---|---|---|---|---|---|---|---|---|
| 1910 | 941 | 0.0186 | 573 | 0.889 | 4.269 × 10⁻⁵ | 42.14 | 995 | 0.998 | 84.77 | 0.979 |
| 2900 | 1446 | 0.0116 | 986 | 0.998 | 2.028 × 10⁻⁵ | 47.86 | 1536 | 1.000 | 121.41 | 0.980 |
| 5096 | 1616 | 0.0139 | 1070 | 0.938 | 1.912 × 10⁻⁵ | 70.87 | 1925 | 0.999 | 137.22 | 0.978 |

Temperature (° C.) t = 6 hr (pH 3.0)

| | | | | | | | | | | |
|---|---|---|---|---|---|---|---|---|---|---|
| 30 | 1680 | 0.0161 | 1887 | 0.971 | 7.793 × 10⁻⁶ | 31.81 | 2020 | 0.997 | 120.80 | 0.991 |
| 40 | 1679 | 0.0221 | 813 | 0.987 | 1.593 × 10⁻⁵ | 55.86 | 1873 | 0.997 | 145.87 | 0.996 |
| 50 | 1652 | 0.0340 | 1284 | 0.871 | 5.037 × 10⁻⁵ | 148.18 | 1715 | 0.997 | 182.94 | 0.981 |

pH t = 48 hr

| | | | | | | | | | | |
|---|---|---|---|---|---|---|---|---|---|---|
| 1.0 | 2089 | 0.0069 | 1179 | 0.924 | 1.559 × 10⁻⁵ | 69.97 | 2119 | 1.000 | 138.52 | 0.966 |
| 3.0 | 1706 | 0.0083 | 700 | 0.858 | 2.376 × 10⁻⁵ | 69.56 | 1711 | 1.000 | 113.06 | 0.993 |
| 6.0 | 1263 | 0.0028 | 385 | 0.688 | 2.454 × 10⁻⁵ | 40.05 | 1278 | 1.000 | 91.43 | 0.978 |

wet/dry t = 48 hr (pH 1.0)

| | | | | | | | | | | |
|---|---|---|---|---|---|---|---|---|---|---|
| wet beads | 2089 | 0.0069 | 1179 | 0.924 | 1.559 × 10⁻⁵ | 69.97 | 2119 | 1.000 | 138.52 | 0.966 |
| dry beads | 2160 | 0.0029 | 2264 | 0.999 | 9.214 × 10⁻⁷ | 6.16 | 2585 | 0.952 | 79.42 | 0.961 |

TABLE 4
The thermodynamic and rate constant parameters
(pH 3.0, particle size 2.3-2.5 mm, and initial
dye conc. 4330 g/m³)

| | Thermodynamics | | | | | Rate constant | | |
|---|---|---|---|---|---|---|---|---|
| Temperature | | ΔG⁰ | ΔH⁰ | ΔS⁰ | | k₀ | E_{ad} | |
| (° C.) | K_{C} | (kJ mol⁻¹) | (kJ mol⁻¹) | (J mol⁻¹ K⁻¹) | R² | (kg g⁻¹ min⁻¹) | (kJ mol⁻¹) | R² |
| 30 | 13.974 | −6.643 | | | | | | |
| 40 | 6.403 | −4.832 | −52.948 | −153.112 | 0.991 | 8.107 × 10⁷ | 75.708 | 0.977 |
| 50 | 3.813 | −3.594 | | | | | | |

I/we claim:

1. A method of adsorbing dye by cross-linked chitosan beads, comprising:
providing chitosan and dissolving said chitosan to form a chitosan solution;
mixing said chitosan solution with a tripolyphosphate (TPP) solution to form ionic cross-linked chitosan beads;
cross-linking said ionic cross-linked chitosan beads to form said cross-linked chitosan beads by adding NaOH and cross-linking agent and shaking for about a first period at a temperature about 25-55 centigrade; and
adding said cross-linked chitosan beads in a dye solution to adsorb said dye.

2. The method of claim 1, wherein said chitosan is dissolved in acetic acid solution.

3. The method of claim 1, after said chitosan dissolved, then stilling said chitosan solution for about a second period.

4. The method of claim 3, wherein said second period is at least 6 hours.

5. The method of claim 1, after mixing said solution with a tripolyphosphate (TPP) solution then letting said mixed chitosan solution stay still for about a third second period.

6. The method of claim 5, wherein said third period is at least 4 hours.

7. The method of claim 1, wherein said cross-linking agent includes epichlorohydrin (ECH).

8. The method of claim 1, wherein said cross-linking agent includes glutaraldehyde (GA).

9. The method of claim 1, wherein said cross-linking agent includes ethylene glycol diglycidyl ether (EGDE).

10. The method of claim 5, wherein said first period is at least 6 hours.

11. The method of claim 5, wherein said cross-linked chitosan beads is used in acid or neutral solution to adsorb reactive type dye, acid type dye or direct type dye.

12. A method of forming chitosan beads, comprising:
dissolving chitosan in acetic acid solution to form a chitosan solution;
letting said chitosan solution stay still for about a first period;
mixing said chitosan solution with a tripolyphosphate (TPP) solution to form ionic cross-linked chitosan beads;
letting said chitosan solution stay still for about a second period.

13. The method of claim 12, wherein said second period is at least 4 hours.

14. The method of claim 12, wherein said cross-linked chitosan beads is used in acid or neutral solution to adsorb reactive type dye, acid type dye or direct type dye.

15. A method of forming cross-linked chitosan beads, comprising:
dissolving chitosan in acetic acid solution to form a chitosan solution;
letting said chitosan solution stay still for about a first period;
mixing said chitosan solution with a tripolyphosphate (TPP) solution to form ionic cross-linked chitosan beads;
stilling said chitosan solution stay still for about a second period, cross-linking said ionic cross-linked chitosan beads to form said cross-linked chitosan beads by adding NaOH and cross-linking agent and shaking for about a third period at a temperature about 25-55 centigrade.

16. The method of claim 15, wherein said cross-linking agent includes epichlorohydrin (ECH).

17. The method of claim 15, wherein said cross-linking agent includes glutaraldehyde (GA).

18. The method of claim 15, wherein said cross-linking agent includes ethylene glycol diglycidyl ether (EGDE).

19. The method of claim 15, wherein said cross-linked chitosan beads is used in acid or neutral solution to adsorb reactive type dye, acid type dye or direct type dye.

20. A chitosan beads adsorbent comprising:
pluralities of particle having average diameter about 680 micron meters for using in acid or neutral solution to adsorb reactive type dye, acid type dye or direct type dye, wherein said chitosan beads adsorbent is prepared by cross-linked chitosan adding ECH, GA or EGDE as the cross-linking agent.
